(19) United States
(12) Patent Application Publication
(10) Pub. No.: US 2012/0250912 A1
(43) Pub. Date: Oct. 4, 2012

(54) LINE SPEAKER SYSTEM AND LAYOUT

(75) Inventor: Wan Jin Chung, Seoul (KR)

(73) Assignee: Wan Jin Chung, Seoul (KR)

(21) Appl. No.: 13/412,391

(22) Filed: Mar. 5, 2012

Related U.S. Application Data
(60) Provisional application No. 61/449,610, filed on Mar. 4, 2011.

(51) Int. Cl. H04R 5/02; H04R 1/02

(52) U.S. Cl. 381/306; 381/332; 381/300

(57) ABSTRACT

A layout of line speakers reduces feedback and provides more uniform sound amplification throughout a listening area. The length of one or more line speakers is selected so that the line speakers behave as line acoustic sources throughout a listening area. The line speakers are further positioned so that a stage area is located in a null zone of each line speaker to minimize the likelihood of feedback events.

### CROSS-REFERENCE TO RELATED APPLICATION(S)

This application claims the benefit of U.S. Provisional Patent Application Ser. No. 61/449,610, filed Mar. 4, 2011, which is incorporated by reference herein.

### BACKGROUND OF THE INVENTION

1. Field of the Invention

Embodiments of the present invention generally relate to speaker systems and, more specifically, to a line speaker system and configuration for an auditorium or other large listening area.

2. Description of the Related Art

In auditoriums and other public venues, sound delivery systems are used to amplify voice, music, and other sound produced on a stage for an audience distributed over a relatively large area. It is common practice for such sound delivery systems to include multiple electro-acoustic transducers, also referred to as loudspeakers, situated in one or more locations in or around the listening area. While the loudspeakers of auditorium sound delivery systems are of course much larger than a theoretical point, in practice each such loudspeaker acts essentially as a point source of sound, i.e., sound produced by each loudspeaker radiates outward in a spherical wave pattern.

FIG. 1 schematically illustrates a speaker stack 100 that may be used as part of a sound deliver system for an auditorium or other large venue. Speaker stack 100 has a standard configuration commonly known in the art and includes multiple electro-acoustic transducers, i.e., a tweeter 101, a mid-range transducer 102, and a woofer 103, which are disposed on a planar surface 110 of speaker stack 100 as shown. Although tweeter 101, mid-range transducer 102, and woofer 103 are arranged on planar surface 110 and have finite dimensions, relative to the dimensions of an auditorium in which they are used, each of these transducers has negligible extent and acts as a point source of sound waves. Consequently, sound waves radiate from each transducer of speaker stack 100 in a substantially spherical wave, as illustrated in FIG. 2.

FIG. 2 illustrates a plan view of speaker stack 100. As shown, spherical sound waves 200 emanate from each transducer of speaker stack 100 in a substantially spherical fashion, which has two important drawbacks. First, the sound pressure of spherical sound waves 200, i.e., the perceived volume to a listener, is inversely proportional to the square of the distance of the listener from speaker stack 100. This results in a high sound-pressure gradient across a listening area served by speaker stack 100. Thus, listeners located in portions of a listening area proximate speaker stack 100 must be subjected to uncomfortably high sound volumes to ensure that listeners located in more remote portions of the listening area experience a minimum acceptable sound volume from speaker stack 100. Second, positive feedback between speaker stack 100 and any microphone located in an auditorium served by speaker stack 100 is difficult to avoid. This is due to the omni-directional nature of spherical sound waves 200 emanating from the point-source transducers of speaker stack 100. As shown in FIG. 2, a microphone 250 can be located behind planar surface 110, for example on a stage 260, and still form a sound loop with one or more of the transducers of speaker stack 100, creating the familiar high-pitched and unpleasant squeal commonly experienced by listeners in large auditoriums.

In light of the forgoing, there is a need in the art for a sound delivery system that provides more uniform sound volume throughout a large listening area while minimizing the potential for feedback with microphones disposed outside the listening area.

### SUMMARY OF THE INVENTION

One or more embodiments of the invention provide a line speaker system configured to reduce feedback and provide more uniform sound amplification throughout a listening area. In one embodiment, the length of one or more line speakers is selected so that the line speakers behave as line acoustic sources throughout a listening area. These line speakers are also positioned so that a stage area is located in a null zone of each line speaker to minimize the likelihood of feedback events.

A sound system for a venue having a stage and a listening area, according to an embodiment of the invention includes a line speaker disposed above the listening area and extending in a straight line away from the stage such that the listening area lies in a primary sound output zone of the line speaker and the stage lies in a null zone of the line speaker. The line speaker may be arranged horizontally and supplemented with a pair of vertical or substantially vertical line speakers disposed at a distal end of the listening area with respect to the stage, and/or a pair of horizontally arranged line speakers on either side of the stage disposed above the listening area and extending away from the stage in a direction perpendicular to a direction of extension of the line speaker.

A speaker system, according to an embodiment of the invention includes first and second line speakers extending in parallel above a listening area and spaced apart to produce stereo sound in substantially all of the listening area. The listening area may be an auditorium, a movie theater, a concert hall, an assembly hall, or any other similar venues, indoor or outdoor, where sound needs to be delivered to a large number of people.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a speaker stack that may be used as part of a sound deliver system for an auditorium or other large venue.

FIG. 2 illustrates a plan view of the speaker stack in FIG. 1.

FIGS. 3A and 3B schematically illustrate a single line-speaker configuration in an auditorium, according to an embodiment of the invention.

FIGS. 4A and 4B schematically illustrate front and side views, respectively, of an example configuration of a line speaker that may be used in embodiments of the present invention.

FIG. 5 schematically illustrates an exemplary configuration of a line speaker having a three-channel line array of electro-acoustic transducers that may be used in embodiments of the invention.

FIG. 6A schematically illustrates one exemplary configuration of a line speaker that may be used in embodiments of the invention.

FIG. 6B schematically illustrates another exemplary configuration of a line speaker that may be used in embodiments of the invention.

FIG. 6C schematically illustrates another exemplary configuration of a line speaker that may be used in embodiments of the invention.

FIG. 7 schematically illustrates an exemplary configuration of multiple line speakers arranged in an array that has performance similar to an ideal acoustic line source.

FIG. 8 schematically illustrates a plan view of a dual line-speaker configuration in an auditorium, according to an embodiment of the invention.

FIGS. 9A and 9B schematically illustrate a multiple line-speaker configuration in an auditorium, according to an embodiment of the invention.

FIG. 10 schematically illustrates a multiple line-speaker configuration in an auditorium, according to an embodiment of the invention.

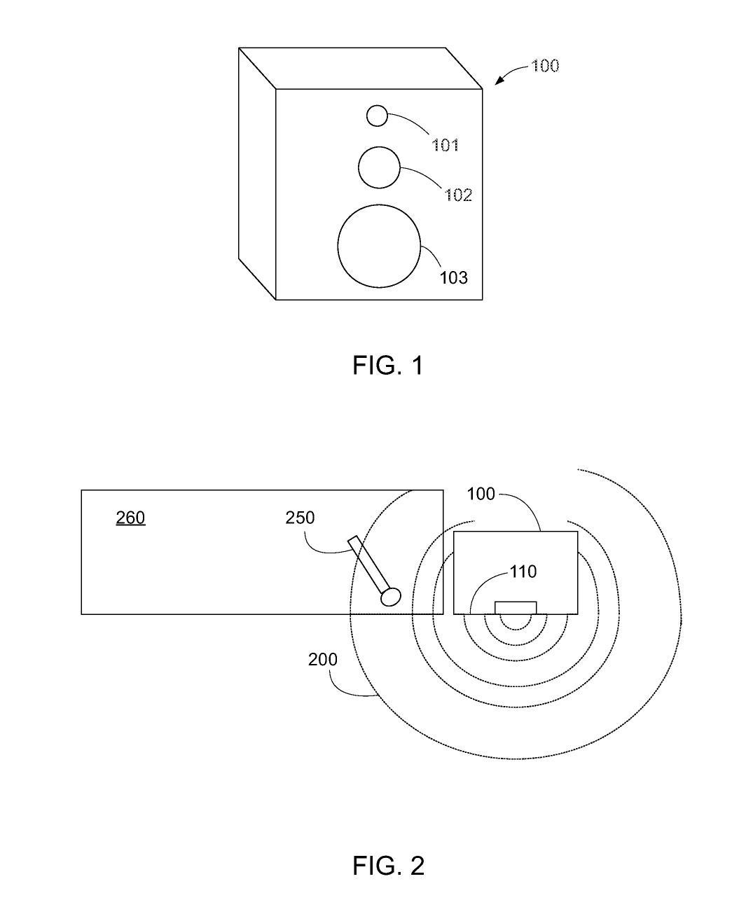

For clarity, identical reference numbers have been used, where applicable, to designate identical elements that are common between figures. It is contemplated that features of one embodiment may be incorporated in other embodiments without further recitation.id

### DETAILED DESCRIPTION

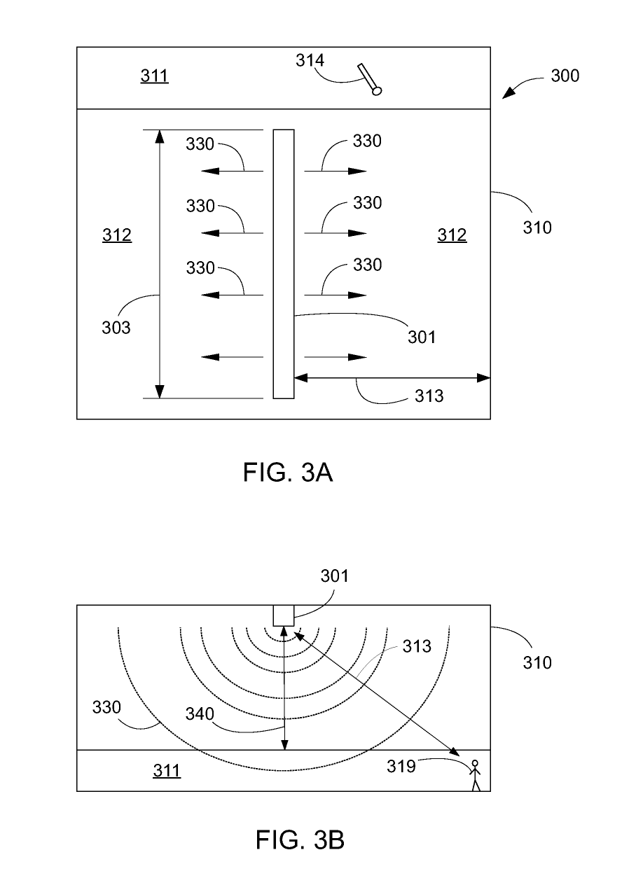

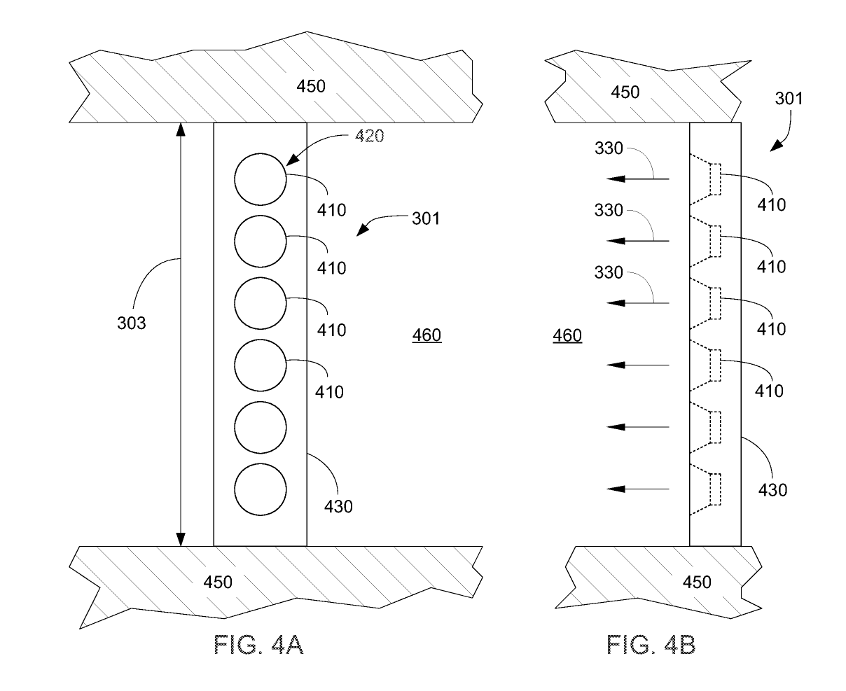

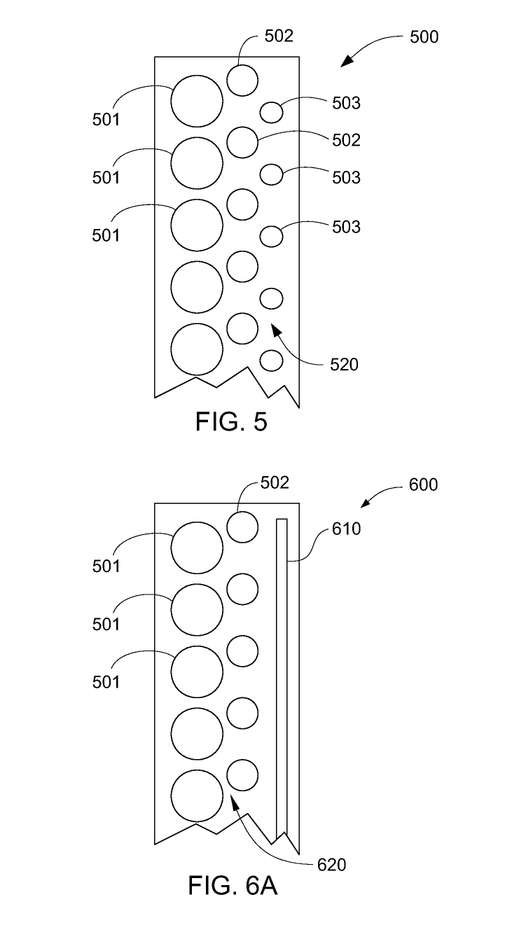

One or more embodiments of the invention provide a line speaker system configured to reduce feedback and provide more uniform sound amplification throughout a listening area. FIGS. 3A and 3B schematically illustrate a single line-speaker configuration 300 in an auditorium 310, according to an embodiment of the invention. FIG. 3A is a plan view of single line-speaker configuration 300 and auditorium 310 and FIG. 3B is an elevation view of single line-speaker configuration 300 and auditorium 310. Auditorium 310 may be a small auditorium, such as a church or gymnasium, and includes a stage 311 with one or more microphones 314 and a listening area 312 intended for a sizable audience. In single line-speaker configuration 300, a single line speaker 301 is positioned substantially horizontally above a center region of listening area 312 and oriented so that stage 311 is located in a “null zone” of line speaker 301, i.e., in an area outside the primary output zone of line speaker 301. To that end, in the embodiment illustrated in FIG. 3, line speaker 301 is oriented with the long axis of line speaker 301 substantially toward stage 311. The location of the null zones of line speaker 301 are described below in conjunction with FIGS. 4A, 4B, and the organization and operation of different embodiments of line speaker 301 are described below in conjunction with FIGS. 5, 6A-6C, and 7.

In single line-speaker configuration 300, length 303 of line speaker 301 is selected to be substantially equal to or greater than distance 313, which is the maximum distance sound 330 must travel from line speaker 301 to listeners 319 in auditorium 310. When length 303 of line speaker 301 is so selected, line speaker 301 behaves as a line acoustic source for listeners 319, since listeners 319 are situated at a distance less than or equal to length 301 from line speaker 300. Because line speaker 301 acts as a line acoustic source in single line-speaker configuration 300, the energy distribution of sound 330 radiating from line speaker 301 is distributed over the surface of a cylinder, whose surface area increases proportional to the radius. Thus, sound pressure level (SPL) of line speaker 300 as perceived by a listener in auditorium 310 falls off in proportion to the distance of the listener from line speaker 301. In other words, SPL falls off at a rate of about 3 dB per doubling of distance from line speaker 301. In contrast, for listeners situated at a distance more than length 303 from line speaker 301, line speaker 301 begins behaving more like a point source, and the SPL of line speaker 301 falls off at rate of about 6 dB per doubling of distance therefrom. This is because the energy distribution of sound emanating from a point source is distributed over the surface of a sphere, whose surface area increases in proportion to the square of the radius of the sphere. Thus, because length 303 of line speaker 301 is selected so that line speaker 301 behaves as a line acoustic source for listeners 319, the high SPL gradient across listening area 312 that would occur when point source speakers are used to serve listening area 312 is largely avoided.

As noted above, stage 311 is located in a null zone of line speaker 301. Thus, while substantially all of listening area 312 is inside the primary output zone of line speaker 301, microphone 314 is positioned outside the primary output zone of line speaker 301. When located in a null zone, microphone 314 receives very little of sound 330, thereby minimizing the potential for feedback incidents. In addition, the directional output of line speaker 301 greatly reduces the potential for reflection of sound from rear wall 319 toward microphone 314. Uniformity of SPL throughout listening area 312 is further increased because line speaker 301 is positioned at a height 340 above listening area 312 rather than at the same level as listeners located therein; when positioned at height 340, the difference between the maximum and minimum distance that listeners can be positioned from line speaker 301 is significantly reduced. It is noted that in some embodiments, height 340 of line speaker 301 above listening area 312 may be selected to optimize maximize uniformity of SPL in listening area 312 and minimize the potential for feedback events with microphone 314.

FIGS. 4A and 4B schematically illustrate front and side views, respectively, of an example configuration of line speaker 301 that may be used in embodiments of the present invention. Line speaker 301 includes multiple electro-acoustic transducers 410 arranged in a line array 420 and mounted at very short intervals in a cabinet 430 to simulate a straight line acoustic source of audio power, rather than multiple point sources. In some embodiments, each of electro-acoustic transducers 410 is configured to simultaneously produce substantially identical sound output to better simulate a line acoustic source. In addition, line speaker 301 is configured with length 303 that allows line speaker 301 to act as essentially a line source for listeners located in a desired listening area as described above in conjunction with FIG. 3. In some embodiments, multiple cabinets 430 containing electro-acoustic transducers 410 may be positioned end-to-end to provide a desired length 303 for line speaker 301.

The directional characteristics of sound emanating from a line acoustic source such as line speaker 301 result in null zones 450 that are disposed adjacent to line speaker 301. Null zones 450 are regions in which the SPL of sound 330 emanating from line speaker 301 is significantly lower than the SPL in a primary output zone 460 of line speaker 301. Null zones 450 are formed because the major lobe of sound radiation emanating from a line acoustic source, e.g., primary output zone 460, is directed normal to the major axis of the line acoustic source, and as the length of the line acoustic source is increased in length from a fraction of a wavelength to a plurality of wavelengths, the major lobe becomes narrower, i.e., more confined in directionality. Consequently, unlike the SPL in primary output zone 460, the SPL in null zones 450 is not simply a function of distance from transducers 410 and instead is at a relatively low level, even in portions of null zones 450 that are proximate to line speaker 301.

Line array 420 includes a plurality of transducers 410 disposed in a line substantially orthogonal to the primary radiation direction of transducers 410 and line speaker 301. Transducers 410 may all be identical transducers, such as full-range transducers, each of which is configured to reproduce as much of the audible frequency range as possible. Alternatively, transducers 410 may include a combination of different transducers configurations, each configuration being selected for reproducing different frequency ranges in the audible range. Thus, transducers 410 may include two or more different types of electro-acoustic transducer, such as subwoofers for very low frequencies, woofers for low frequencies, mid-range speakers for middle frequencies, tweeters for high frequencies, and/or supertweeters optimized for the highest audible frequencies. For example, in a two-channel embodiment, transducers 410 may include woofers and tweeters which are alternated, paired together, or otherwise arranged in a repeating pattern in line array 420. In a three-channel embodiment, transducers 410 may include woofers, mid-range speakers, and tweeters arranged in a repeating pattern.

FIG. 5 schematically illustrates an exemplary configuration of a line speaker 500 having a three-channel line array 520 of electro-acoustic transducers that may be used in embodiments of the invention. As shown, line speaker 500 includes a plurality of three different types of electro-acoustic transducer: woofers 501, mid-range speakers 502, and tweeters 503. Woofers 501, mid-range speakers 502, and tweeters 503 are closely spaced and arranged in a repeating pattern to simulate a line acoustic source. Typically, woofers 501 are electrically connected in parallel, to ensure a synchronous pulse response, and the individual speaker impedance of woofers 501 is adapted in such a way that the total impedance will not get too low. Similarly, mid-range speakers 502 are typically electrically connected in parallel, and tweeters 503 are electrically connected in parallel. To avoid unwanted vertical distribution lobes that can extend into desired null zones of line speaker 500, and to achieve maximum coupling between woofers 501, a center-to-center distance 550 between adjacent woofers 501 should generally be less than one half of the wavelength corresponding to a frequency of sound generated by woofers 501. Similarly, a center-to-center distance 560 between adjacent mid-range speakers 502 should generally be less than one half of the wavelength corresponding to a frequency of sound generated by mid-range speakers 502.

For lower frequency sound energy, the repeating pattern of transducers used in line speaker 500 generally provides a high degree of directionality in a plane that includes the line along which individual transducers are arranged. For higher frequencies, however, one or more side lobes generally extend into the null zones of line speaker 500. This is because the length of three-channel line array 520 is equal to or greater than a large number of such high-frequency wavelengths. Consequently, to prevent the radiation of higher frequency lobes off the ends of line speaker 500, an acoustic foam in the shape of a wedge, cube, cylinder, or the like, which may be selected to match the aesthetic design of line speaker 500, may be attached to the ends of line speaker 500. The thickness of the acoustic foam is at least one-fourth of the wavelength that is desired to be suppressed. Thus, if high frequency lobes (e.g., >3000 Hz) are to be suppressed in an environment where the speed of sound is about 343 m/s, the thickness of the acoustic foam should be at least 11.4 cm. In such configurations, it is typical practice for such acoustic foam to be at the desired thickness at the end of line speaker 500 and to decrease in thickness at the middle region of line speaker 500.

In some embodiments, a loudspeaker system may comprise two or more sub-sections, where each sub-section is a single line speaker, such as line speaker 500. Such sub-sections are configured to be attached close to each other, so that together they form one or more extended line-sources, such as line speaker 301 in FIG. 3. In this way, a modular loudspeaker system can be realized that can be easily adapted to various conditions and venue geometries, while still being easy to handle.

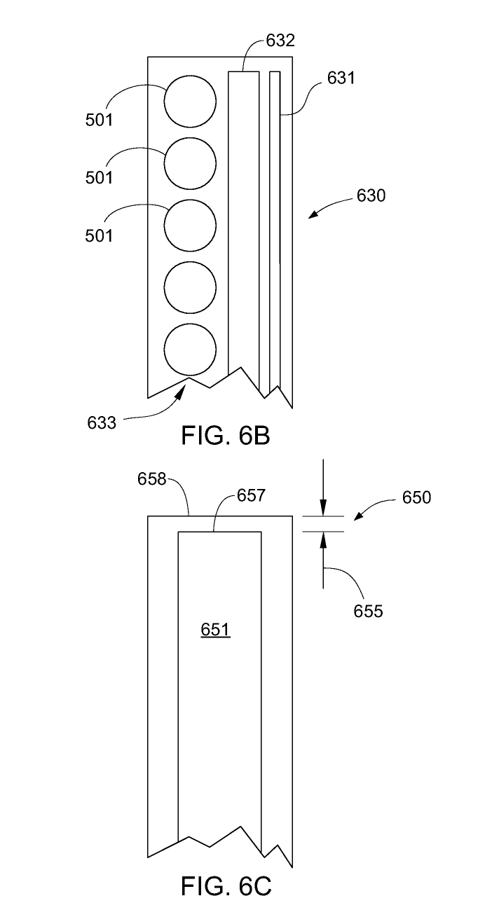

One of skill in the art will appreciate that other configurations of multi-channel line speakers may also be used in embodiments of the invention. For example, one or more of the channels of line array 520 may be configured using one or more elongated transducers, rather than an array of point-source transducers arranged in a closely spaced and repeating pattern, as shown in FIG. 5. Elongated transducers generally provide a more constant sound-pressure across the length of a line speaker, thereby more closely behaving like an ideal line source than the array of point-source transducers illustrated in FIG. 5. Various embodiments of line speakers that may be used in embodiments of the invention and which include one or more elongated transducers and are illustrated in FIGS. 6A-6C.

FIG. 6A schematically illustrates one exemplary configuration of a line speaker 600 that may be used in embodiments of the invention. As shown, line speaker 600 includes an elongated high frequency transducer 610 arranged in parallel with a two-channel line array 620 of woofers 501 and mid-range speakers 502. To achieve maximum coupling between high frequency transducer 610 and two-channel line array 620, high frequency transducer 610 is preferably positioned within about one-half of a wavelength of the sound generated by high frequency transducer 610.

Elongated high frequency transducer 610 has an essentially continuous radiating surface along its axis of elongation, and therefore more closely behaves like an ideal line source than the array of tweeters 503 illustrated in FIG. 5. In some embodiments, elongated high frequency transducer 610 consists of a thin metal-film ribbon suspended in a magnetic field. Such metal-film ribbons have very little mass and can therefore accelerate very quickly, yielding very good high-frequency response. Typically a metal-film ribbon, when used as a so-called “ribbon speaker,” is moveably positioned in an elongated slit between two or more elongated magnet elements that are arranged in parallel with each other. In such configurations, the metal-film ribbon is electrically coupled such that it can conduct a drive current in the longitudinal direction of the ribbon. Any other technically feasible configurations of elongated transducers may also be used for high frequency transducer 610 without exceeding the scope of the invention.

FIG. 6B schematically illustrates another exemplary configuration of a line speaker 630 that may be used in embodiments of the invention. As shown, line speaker 630 includes two elongated transducers 631 and 632, arranged in parallel with a line array 633 of woofers 501. Preferably, elongated high frequency transducers 631 and 632 are positioned no further than about one-half of a wavelength of the sound generated thereby from line array 633. In the configuration illustrated in FIG. 6B, elongated transducer 631 is substantially similar in organization and operation to high frequency transducer 610, described above in conjunction with FIG. 6A. Elongated transducer 632 is also similar in organization and operation to high frequency transducer 610, except that elongated transducer 632 is configured to replace mid-range speakers 502.

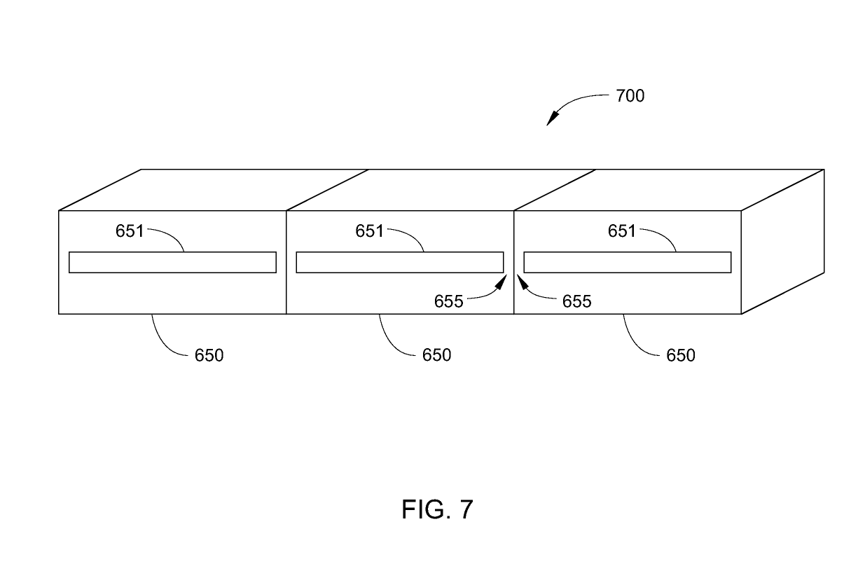

FIG. 6C schematically illustrates another exemplary configuration of a line speaker 650 that may be used in embodiments of the invention. As shown, line speaker 650 includes a single elongated transducer 651. Elongated transducer 651 is configured as a “full-range” speaker, and can be used for audio reproduction applications to simultaneously replace woofers 501, mid-range speakers 502, and tweeters 503 in a line speaker used in embodiments of the invention. Because relatively large diameter point-source speakers are not used in line speaker 650, such as woofers or mid-range speakers, line speaker 650 can be configured with a relatively small gap 655 between an end 657 of elongated transducer 651 and an edge 658 of a cabinet 650. Consequently, multiple line speakers 650 can be arranged as subsections in a single array that behaves like an ideal line source, since elongated transducers 651 are positioned proximate each other with very little gap therebetween. An example of one such array is illustrated in FIG. 7.

FIG. 7 schematically illustrates an exemplary configuration of multiple line speakers 650 arranged in an array 700 that has performance similar to an ideal acoustic line source. As shown, array 700 includes multiple line speaker 650 positioned adjacent to each other. Because line speakers 650 are configured with only a small gap 655 between adjacent elongated transducers 651, elongated transducers 651 of line speakers 650 behave essentially as a continuous acoustic line source. When a large number of line speakers 650 are placed adjacent to each other, the entire length and/or width of an entire auditorium, hall, or other large listening area, or a substantial portion of the length and/or width thereof, can be spanned.

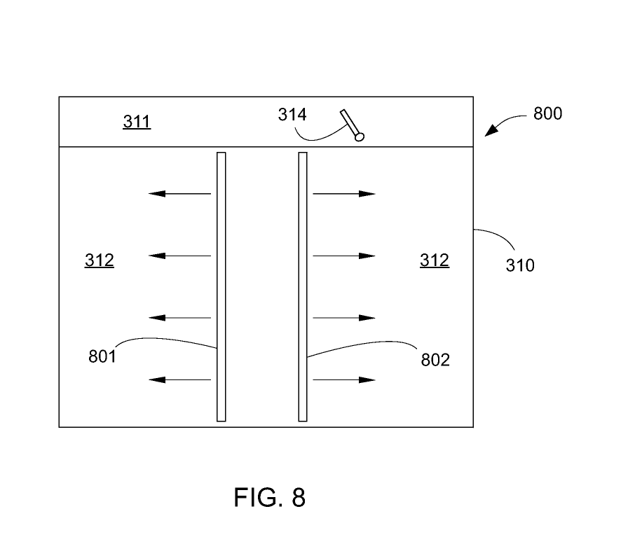

In some embodiments, a loudspeaker system may comprise multiple line speakers. For example, in order to deliver stereo sound to listeners in an auditorium listening area, a dual line-speaker configuration is used to reduce feedback and provide more uniform sound amplification throughout a listening area. FIG. 8 schematically illustrates a plan view of a dual line-speaker configuration 800 in auditorium 310, according to an embodiment of the invention. Auditorium 310 is described above in conjunction with FIG. 3. Dual line-speaker configuration 800 is substantially similar to single line-speaker configuration 300, except that two line speakers 801, 802 are installed in auditorium 310. As shown, stage 311 is positioned in a null zone of each of line speakers 801, 802, and therefore is subject to greatly reduced feedback issues from said line speakers. Line speakers 801, 802 are substantially similar in organization and operation to embodiments of line speaker 301 described above. In addition, line speaker 801 is configured to produce one stereo channel and line speaker 802 is configured to produce the second stereo channel.

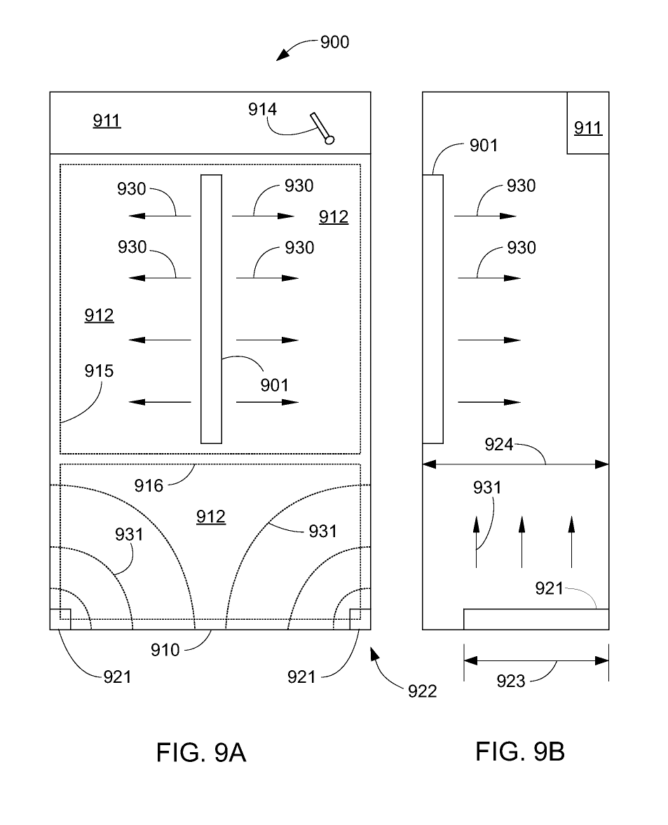

For venues that have a larger listening area, the installation of a line speaker above most of the length of the listening area, as illustrated above in FIG. 3, may be impractical due to cost and/or other constraints. FIGS. 9A and 9B schematically illustrate a multiple line-speaker configuration 900 in an auditorium 910, according to an embodiment of the invention. FIG. 9A is a plan view of multiple line-speaker configuration 900 and auditorium 910, and FIG. 9B is a side elevation view of multiple line-speaker configuration 900 and auditorium 910. Auditorium 910 is a relatively large auditorium, such as a concert hall, and includes a stage 911 with one or more microphones 914 and a large listening area 912 intended for a large audience.

In multiple line-speaker configuration 900, a single line speaker 901 is positioned substantially horizontally above the center of a front zone 915 of listening area 912 of auditorium 910 with the long axis of line speaker 901 oriented substantially toward stage 911 in a similar fashion as line speaker 301 in FIG. 3. Thus, single line speaker 901 acts as a line source of sound 930 for listeners in front zone 915, thereby providing a low SPL gradient across front zone 915 with low risk of feedback through microphone 914. Multiple line-speaker configuration 900 further includes one or more vertically oriented line speakers 921 disposed in a distal zone 916 of listening area 912. Vertically oriented line speakers 921 may be line speakers substantially similar in organization and operation to embodiments of line speaker 301, described above. As shown, vertically oriented line speakers 921 are positioned in distal corners 922 of distal zone 916 and radiate sound 931 into distal zone 916 so that distal zone 916 receives overall a more uniform SPL distribution than when point source speaker systems are used. It is noted that although vertically oriented line speakers 921 radiate sound directly toward microphone 914, in such a configuration the distance between microphone 914 and vertically oriented line speakers 921 is such that feedback events are generally not an issue.

In some embodiments, a more uniform SPL distribution of sound 931 is generated in distal zone 916 by configuring vertically oriented line speakers 921 to act as line sources of sound 931 for listeners in distal zone 916. In one such embodiment, length 923 of vertically oriented line speakers 921 is selected so that most or all portions of distal zone 916 are within a distance from vertically oriented line speakers 921 of no more that about length 923. Because vertically oriented line speakers 921 include a line array of a repeating pattern of identical speakers or identical speaker groups that simultaneously produce substantially identical sound output, each vertically oriented line speaker 921 behaves as a line source of sound 931 within a distance on the order of about length 923. Consequently, vertically oriented line speakers 921 provide a low SPL gradient across listening area 915 when length 923 is selected in this way. Alternatively, length 923 may be selected to be substantially equal to height 924 of distal zone 916. In such an embodiment, vertically oriented line speakers 921 may act as line sources across all of distal zone 916 and front zone 915, since ceiling and floor reflections of a vertically aligned floor-to-ceiling line source cause vertically oriented line speakers 921 to behave substantially like an infinite line rather than a finite line source.

In another embodiment, line speakers 921 are tilted slightly, in one example by about 3-5 degrees from the vertical, so that even if the distance between microphone 914 and line speakers 921 is close enough such that feedback into microphone 914 may be an issue, the tilt of the alignment axis of line speakers 921 causes sound waves generated by line speakers 921 to angle towards the floor and drop to the floor before reaching microphone 914.

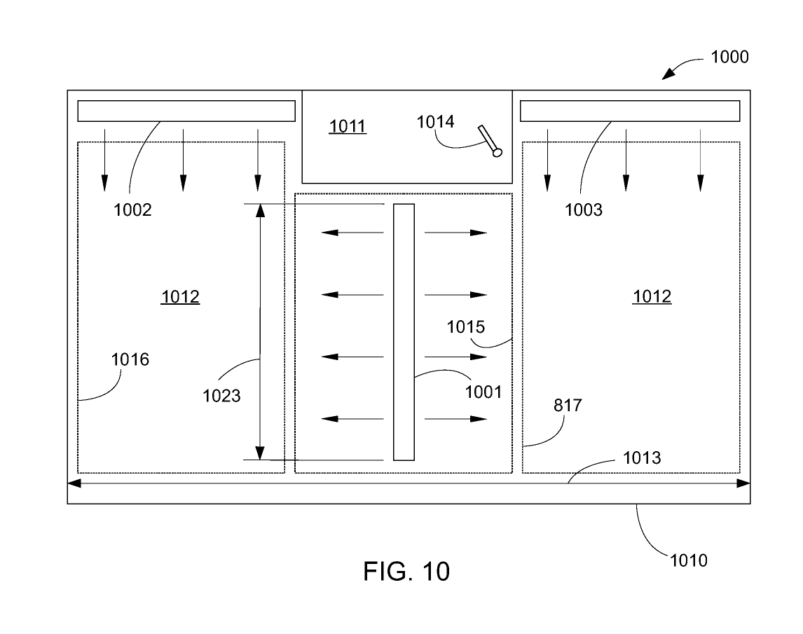

For some venues, the geometry as much as the size of the listening area can make the use of a single line-source speaker problematic. FIG. 10 schematically illustrates a multiple line-speaker configuration 1000 in an auditorium 1010, according to an embodiment of the invention. FIG. 10 is a plan view of multiple line-speaker configuration 1000 and auditorium 1010. Auditorium 1010 may be a relatively large auditorium, such as a concert hall, and includes a stage 1011 with one or more microphones 1014 and a large listening area 1012 intended for a large audience. As shown, listening area 1012 is characterized by having a width 1013 that is substantially greater than length 1023 of line speaker 1001. Line speaker 1001 is positioned substantially horizontally above the center of a middle zone 1015 of listening area 1012 and oriented so that stage 1011 is positioned in a null zone of line speaker 1001, i.e., with the long axis of line speaker 1001 oriented substantially toward stage 1011. In addition, line speakers 1002, 1003 are positioned horizontally and above each side of stage 1011 as shown, so that stage 1011 is also located in a null zone of each of line speakers 1002, 1003.

Because length 1023 of line speaker 1001 is substantially smaller than width 1013, line speaker 1001 behaves more as a point source than a line source inside zones 1017, 1018 of listening area 1012. Consequently, SPL of sound radiating from line speaker 1001 will drop quickly in side zones 1017, 1018. However, line speakers 1002, 1003 are positioned to boost SPL in side zones 1017, 1018 without increasing the likelihood of feedback incidents. For multiple line-speaker configuration 1000, it is noted that as the ratio of width 1013 to length 1023 increases, line speaker 1001 acts as a line acoustic source for a smaller fraction of listening area 1012. However, in such situations line speakers 1002, 1003 behave more like line acoustic sources, thereby compensating for the relatively fast drop-off in SPL from line speaker 1001 in side zones 1017, 1018. Thus, placement of multiple line speakers, according to embodiments of the invention, can provide more uniform SPL distribution in listening areas having many different geometries without increasing the risk of feedback events. Furthermore, additional line speakers may be positioned in a listening area to enhance SPL in regions of the listening area that are otherwise isolated from the primary line speakers by architectural features and other obstructions.

While the foregoing is directed to embodiments of the present invention, other and further embodiments of the invention may be devised without departing from the basic scope thereof, and the scope thereof is determined by the claims that follow.

I claim:

1. A sound system for a venue having a stage and a listening area, comprising at least one line speaker disposed above the listening area and extending in a straight line away from the stage such that the listening area lies in a primary sound output zone of said at least one line speaker and the stage lies in a null zone of said at least one line speaker.

2. The sound system of claim 1, wherein at least two line speakers are disposed above the listening area and extend in a straight line away from the stage such that the listening area lies in a primary sound output zone of said at least two line speakers and the stage lies in a null zone of said at least two lines speakers.

3. The sound system of claim 1, wherein said at least one line speaker has a length that is greater than a minimum length needed for said at least one line speaker to be a line acoustic source to all areas of the listening area.

4. The sound system of claim 1, wherein said at least one line speaker is arranged horizontally.

5. The sound system of claim 4, further comprising a pair of vertical or substantially vertical line speakers disposed at a distal end of the listening area with respect to the stage.

6. The sound system of claim 1, further comprising at least two line speakers that are disposed above the listening area and extend in a straight line away from and on opposite sides of the stage perpendicular to the straight line formed by said at least one line speaker such that the listening area lies in a primary sound output zone of said at least two line speakers and the stage lies in a null zone of said at least two lines speakers.

7. The sound system of claim 1, further comprising a pair of horizontally arranged line speakers on either side of the stage disposed above the listening area and extending away from the stage in a direction perpendicular to a direction of extension of said at least one line speaker.

8. The sound system of claim 1, wherein said at least one line speaker includes a line array of woofers, mid-range speakers, and tweeters.

9. A speaker system comprising first and second line speakers extending in parallel above a listening area and spaced apart to produce stereo sound in substantially all of the listening area.

10. The speaker system of claim 9, wherein each of the first and second line speakers includes a line array of woofers, mid-range speakers, and tweeters.

11. The speaker system of claim 9, wherein each of the first and second line speakers has a length that is greater than a minimum length needed for each of the first and second line speakers to be a line acoustic source to all areas of the listening area.

12. The speaker system of claim 9, wherein the listening area is an auditorium.

13. The speaker system of claim 9, wherein the listening area is a movie theatre.

14. The speaker system of claim 9, wherein the listening area is a concert hall.

15. The speaker system of claim 9, wherein the listening area is an assembly hall.
